(19) United States
(12) Patent Application Publication
(10) Pub. No.: US 2019/0171782 A1
(43) Pub. Date: Jun. 6, 2019

(54) STORAGE DEVICE HAVING EQUIVALENT CIRCUIT OF INDUCTOR STORED THEREIN, AND SERVER FOR PROVIDING EQUIVALENT CIRCUIT OF INDUCTOR

(71) Applicant: SAMSUNG ELECTRO-MECHANICS CO., LTD., Suwon-Si (KR)

(72) Inventors: Jin Hwan KIM, Suwon-Si (KR); Jong Hwan PARK, Suwon-Si (KR); Bum Sik WANG, Suwon-Si (KR)

(21) Appl. No.: 16/011,040

(22) Filed: Jun. 18, 2018

(30) Foreign Application Priority Data
Dec. 6, 2017 (KR) 10-2017-0166973

(51) Int. Cl. G06F 17/50; G06F 17/30

(52) U.S. Cl. CPC G06F 17/5036; G06F 17/30067

(57) ABSTRACT

There are provided a storage device having an equivalent circuit of an inductor stored therein and a server for providing an equivalent circuit of an inductor. The storage device stores an equivalent circuit. The equivalent circuit includes: a first inductor; and a first functional module connected to the first inductor and adjusting an inductance of the first inductor depending on a direct current (DC) current flowing from a first terminal to a second terminal. The equivalent circuit is an equivalent circuit of an inductor connected between opposite terminals of an inductor device.

### CROSS-REFERENCE TO RELATED APPLICATION(S)

This application claims benefit of priority to Korean Patent Application No. 10-2017-0166973 filed on Dec. 6, 2017 in the Korean Intellectual Property Office, the disclosure of which is incorporated herein by reference in its entirety.

### TECHNICAL FIELD

The present disclosure relates to a storage device having an equivalent circuit of an inductor for a simulation stored therein, and a server for providing an equivalent circuit of an inductor.

### BACKGROUND

Recently, in accordance with rapid technological change, it has been very important to shorten a development period and secure reliability of a product in an actual environment. Therefore, before a pilot product is manufactured and verified in a developing process, a simulation may be performed using a computer to contribute to the shortening of a development period. Such a simulation using a computer may be performed using an equivalent circuit of an actual component. In this case, as physical characteristics of the actual component are more accurately reflected in the equivalent circuit, accuracy of the simulation is further improved. Resultantly, the development period may further be shortened, and product reliability may also be improved.

### SUMMARY

An aspect of the present disclosure may provide a storage device having an equivalent circuit of an inductor stored therein.

An aspect of the present disclosure may also provide a server for providing an equivalent circuit of an inductor.

According to an aspect of the present disclosure, a storage device may store an equivalent circuit. The equivalent circuit having a first terminal and a second terminal may include: a first inductor; and a first functional module connected to the first inductor and adjusting an inductance of the first inductor depending on a direct current (DC) current flowing from the first terminal to the second terminal. The equivalent circuit may be an equivalent circuit of an inductor connected between opposite terminals of an inductor device.

According to another aspect of the present disclosure, a server may store a file including an equivalent circuit, accessible to a user terminal. The equivalent circuit having a first terminal and a second terminal may include: a first inductor; and a first functional module connected to the first inductor and adjusting an inductance of the first inductor depending on a DC current flowing from the first terminal to the second terminal. The equivalent circuit maybe an equivalent circuit of an inductor connected between opposite terminals of an inductor device.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic view illustrating a system including a server for providing an equivalent circuit of an inductor according to an exemplary embodiment in the present disclosure;

FIG. 2 is a circuit diagram illustrating an equivalent circuit of an inductor according to an exemplary embodiment in the present disclosure;

FIG. 3 is a schematic circuit diagram illustrating an example of a functional module of the equivalent circuit of the inductor according to an exemplary embodiment in the present disclosure illustrated in FIG. 2;

FIG. 4 is a schematic perspective view illustrating a coupled power inductor; and

FIG. 5 is a circuit diagram illustrating an equivalent circuit of a coupled power inductor according to an exemplary embodiment in the present disclosure.

### DETAILED DESCRIPTION

Hereinafter, exemplary embodiments of the present disclosure will now be described in detail with reference to the accompanying drawings.

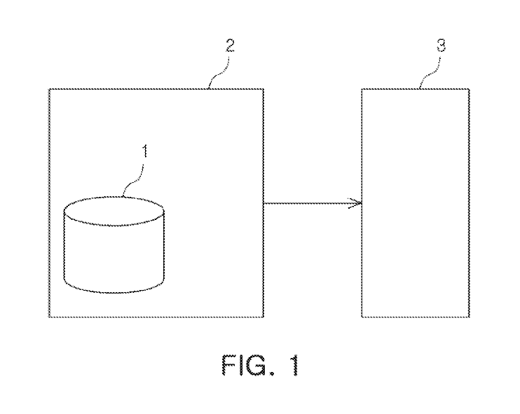

FIG. 1 is a schematic view illustrating a system including a server for providing an equivalent circuit of an inductor according to an exemplary embodiment in the present disclosure.

A server 2 may include a storage device 1, and may provide an equivalent circuit of an inductor stored in the storage device 1 to a user terminal 3 when it receives a request for provision of the equivalent circuit of the inductor from the user terminal 3. To this end, the user terminal 3 may access the server 2 in a wired or wireless manner.

A user may receive the equivalent circuit of the inductor using the user terminal 3, and may perform a simulation on various circuits including the inductor, using the received equivalent circuit of the inductor. The user terminal 3 may include a personal computer, a server computer, a handheld or laptop device, a mobile device (a mobile phone, a personal digital assistants (PDA), a media player, or the like), a multiprocessor system, a consumer electronic device, a mini computer, a mainframe computer, a distributed computing environment including any system or device described above, and the like, but is not limited thereto.

According to the exemplary embodiment, the equivalent circuit of the inductor may be a file implemented using computer readable programming languages. In addition, the equivalent circuit of the inductor may be a set of programming languages. In addition, the equivalent circuit of the inductor implemented by the file (that is, the set of programming languages) may be stored in the storage device 1 included in the server 2, as illustrated in FIG. 1. The storage device 1 may be amass storage device such as a hard disk drive (HDD) or a solid state drive (SSD).

A case in which the equivalent circuit of the inductor is stored in the storage device 1 included in the server 2 is illustrated in FIG. 1, but according to the exemplary embodiment in the present disclosure, the storage device having the equivalent circuit of the inductor stored therein is not particularly limited. That is, various storage devices such as an optical disk or a portable storage device, for example, a universal serial bus (USB) memory, and the like, maybe the storage device having the equivalent circuit of the inductor stored therein according to the exemplary embodiment in the present disclosure.

Although not illustrated in FIG. 1, the user terminal 3 may include a processing unit and a memory. The processing unit may include, for example, a central processing unit (CPU), a graphic processing unit (GPU), a microprocessor, an application specific integrated circuit (ASIC), a field programmable gate arrays (FPGA), or the like, and have a plurality of cores. The memory may be a volatile memory (for example, a random access memory (RAM), or the like), a non-volatile memory (for example, a read only memory (ROM), a flash memory, or the like), or a combination thereof. The equivalent circuit of the inductor received from the server 2 may be loaded in the memory in order to be executed by the processing unit. In this case, a program for simulating a circuit including the inductor may also be loaded into the memory.

Although not illustrated, the user terminal 3 may include a communications connection (communications connections) enabling a computing device to communicate with another device (for example, a computing device). Here, the communications connection (connections) may include a modem, a network interface card (NIC), an integrated network interface, a radio frequency transmitter/receiver, an infrared port, a universal serial bus (USB) connection, or another interface for connecting the computing device to another computing device. In addition, the communications connection (connections) may include a wired connection or a wireless connection.

In addition, as described above, according to the exemplary embodiment in the present disclosure, the storage device having the equivalent circuit of the inductor stored therein may be the portable storage device. In this case, the user terminal may be connected to the portable storage device by various interconnections (for example a peripheral component interconnection (PCI), a USB, firmware (IEEE 1394), an optical bus structure, and the like).

Terms “component”, “module”, and the like, used in the present specification generally refer to a computer related entity, which is hardware, a combination of hardware and software, software, or software that is being executed. For example, the module may be a process that is being executed on a processor, the processor, an object, an executable structure, an executing thread, a program and/or a computer, but is not limited thereto. For example, both of an application that is being driven on a controller and the controller may be a component. One or more components may exist in the process and/or the executing thread, and the component may be localized on one computer or be distributed between two or more computers.

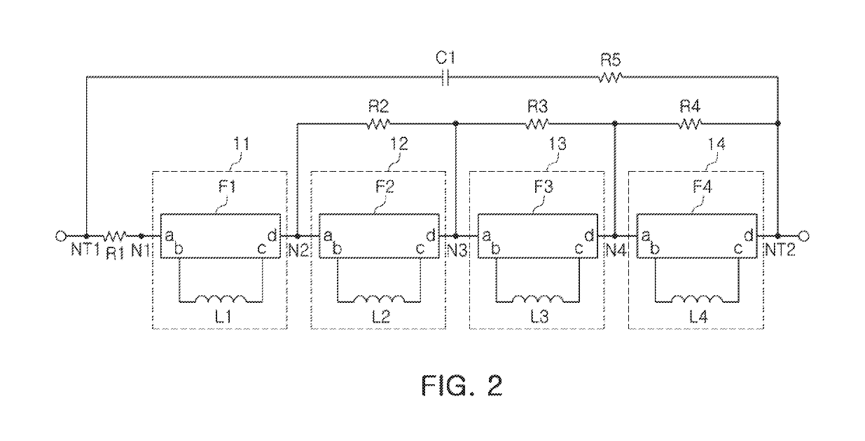

FIG. 2 is a circuit diagram illustrating an equivalent circuit of an inductor according to an exemplary embodiment in the present disclosure. In FIG. 2, NT1 and NT2 refer to both terminals of the inductor.

The equivalent circuit of the inductor according to the exemplary embodiment in the present disclosure may include a first resistor R1 connected between a first terminal NT1 and a first node N1, a first variable inductance module 11 connected between the first node N1 and a second node N2, a second variable inductance module 12 connected between the second node N2 and a third node N3, a third variable inductance module 13 connected between the third node N3 and a fourth node N4, a fourth variable inductance module 14 connected between the fourth node N4 and a second terminal NT2, a second resistor R2 connected to the second variable inductance module 12 in parallel, a third resistor R3 connected to the third variable inductance module 13 in parallel, a fourth resistor R4 connected to the fourth variable inductance module 14 in parallel, and a capacitor C1 and a fifth resistor R5 disposed between the first terminal NT1 and the second terminal NT2 and connected to each other in series. Although in the exemplary embodiment shown in FIG. 2, the capacitor C1 and the fifth resistor R5 are connected to each other in series between the first terminal NT1 and the second terminal NT2, the present disclosure is not limited thereto. Alternatively and/or optionally, the capacitor C1 and the fifth resistor R5 may be connected in parallel between the first terminal NT1 and the second terminal NT2.

The first variable inductance module 11 may include a first functional module F1 and a first inductor L1, the second variable inductance module 12 may include a second functional module F2 and a second inductor L2, the third variable inductance module 13 may include a third functional module F3 and a third inductor L3, and the fourth variable inductance module 14 may include a fourth functional module F4 and a fourth inductor L4.

A total sum of inductances of the first inductor L1, the second inductor L2, the third inductor L3, and the fourth inductor L4 may be set to be the same as an inductance of an inductor that is to be represented by an equivalent circuit. For example, when an inductor having an inductance of 4 μF is represented as an equivalent circuit, inductances of the first inductor L1, the second inductor L2, the third inductor L3, and the fourth inductor L4 may be set to 2 μF, 1μ, 0.5μ, and 0.5 μF, respectively.

The first variable inductance module 11, the second variable inductance module 12, the third variable inductance module 13, and the fourth variable inductance module 14 may serve as inductors having inductances determined depending on magnitudes of direct current (DC) currents flowing to an inductor that is to be represented as an equivalent circuit.

That is, the first functional module F1 may serve to be replaced by an inductor having an inductance determined to be the product of a coefficient determined depending on a magnitude of a DC current flowing to the inductor that is to be represented as the equivalent circuit by the first variable inductance module 11 and the inductance of the first inductor L1. The second functional module F2 may serve to be replaced by an inductor having an inductance determined to be the product of a coefficient determined depending on a magnitude of a DC current flowing to the inductor that is to be represented the an equivalent circuit by the second variable inductance module 12 and the inductance of the second inductor L2. The third functional module F3 may serve to be replaced by an inductor having an inductance determined to be the product of a coefficient determined depending on a magnitude of a DC current flowing to the inductor that is to be represented as the equivalent circuit by the third variable inductance module 13 and the inductance of the third inductor L3. The fourth functional module F4 may serve to be replaced by an inductor having an inductance determined to be the product of a coefficient determined depending on a magnitude of a DC current flowing to the inductor that is to be represented as the equivalent circuit by the fourth variable inductance module 14 and the inductance of the fourth inductor L4.

Resistances of the first resistor R1, the second resistor R2, the third resistor R3, the fourth resistor R4, the fifth resistor R5, and a capacitance of the capacitor C1 may be determined depending on physical characteristics, frequency characteristics, and the like, of the inductor that is to be represented as the equivalent circuit.

In addition, the second variable inductance module 12, the third variable inductance module 13, and the fourth variable inductance module 14 may be used to reflect the frequency characteristics of the inductor that is to be represented as the equivalent circuit as well as reflect DC bias characteristics of the inductor that is to be represented by the equivalent circuit.

A case in which four variable inductance modules are used is illustrated in FIG. 2, but the number of variable inductance modules may be determined as needed. The circuit between the terminals NT1 and NT2 shown in FIG. 2 may be equivalent to an inductor embedded in a body of an inductor device between two terminals disposed on exterior surfaces of the body and connected to opposite ends of the inductor.

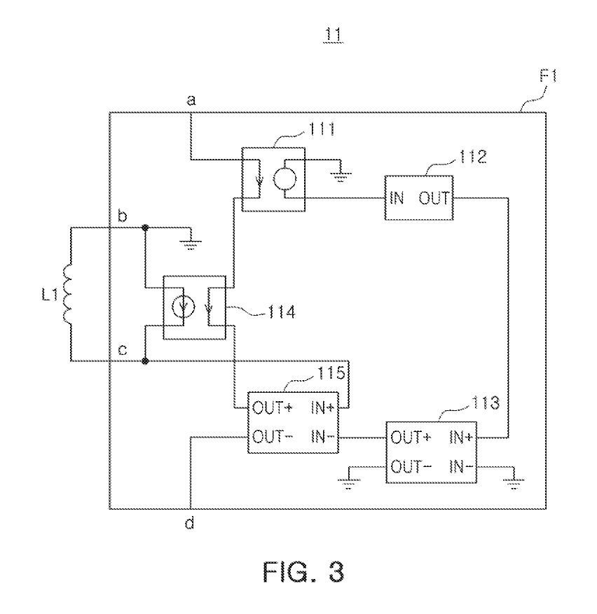

FIG. 3 is a schematic circuit diagram illustrating an example of a first variable inductance module of the equivalent circuit of the inductor according to an exemplary embodiment in the present disclosure illustrated in FIG. 2. Terminals a, b, c, and d of FIG. 3 refer to the same terminals as the terminals a, b, c, and d of the first functional module F1 of FIG. 2. That is, the terminal a may be an input terminal of the first functional module F1, the terminal b may be a terminal connected to one end of the first inductor L1, the terminal c may be a terminal connected to the other end of the first inductor L1, and the terminal d may be an output terminal of the first functional module F1.

The first functional module F1 may be implemented in a form in which it invokes a specific function. In detail, the first functional module F1 may serve to determine a predetermined coefficient depending on a DC current flowing through the first terminal NT1 and the second terminal NT2. For example, the first functional module F1 may return the coefficient determined depending on a value of the DC current with reference to a table in which values of currents and coefficients corresponding to the values of the currents are stored.

Each of a first sub-module 111, a second sub-module 112, a third sub-module 113, a fourth sub-module 114, and a fifth sub-module 115 may be implemented by a predetermined function (or a command or a library) or a plurality of functions (or a plurality of commands or a plurality of libraries). The predetermined function (or command or library) may include information on characteristics of another electronic component or device or a combination of other electronic components or devices. The electronic component or device may be a switch, a transistor, a diode, a resistor, an inductor, a capacitor, a current source, a voltage source, a voltage-to-current converter, or a current-to-voltage converter, although the present disclosure is not limited thereto.

The first sub-module 111 may output DC current information, which is information on a DC current flowing from the first terminal NT1 (see FIG. 2) to the second terminal NT2 (see FIG. 2). The first sub-module 111 may convert the DC current information into a voltage value and output the voltage value.

The second sub-module 112 may output an absolute value of the DC current information.

The third sub-module 113 may output a coefficient determined depending on the absolute value of the DC current information. The third sub-module 113 may output a coefficient that is decreased as the absolute value of the DC current information is increased. For example, the third sub-module 113 may output 1 when the absolute value of the DC current information is 0, output 0.8 when the absolute value of the DC current information is 1, and output 0.7 when the absolute value of the DC current information is 2. The third sub-module 113 may include a lookup table, or the like, and output the coefficient with reference to the lookup table.

For example, the lookup table may be the same as the following Table 1.

TABLE 1

| DC Current | Coefficient |
|---|---|
| 0 | 1 |
| 1 | 0.8 |
| 2 | 0.7 |

The third sub-module 113 may also calculate the coefficient on the basis of the lookup table. For example, when the absolute value of the DC current information is 1.5, the third sub-module 113 may calculate that the coefficient is 0.75.

The fourth sub-module 114 may output information on an inductance of the first inductor L1 connected between the terminal b and the terminal c. For example, the fourth sub-module 114 may allow a current currently flowing from the terminal a to the terminal d to flow from the terminal b to the terminal c to allow a voltage of the terminal c to be a voltage determined by the inductance of the first inductor L1 and output the voltage of the terminal c.

The fifth sub-module 115 may multiply an output value of the fourth sub-module 114 by an output value of the third sub-module 113 and output a result obtained by the multiplication. For example, the fifth sub-module 115 may output a voltage obtained by a voltage applied across the first inductor L1 by the current currently flowing from the terminal a to the terminal d by the coefficient output from the third sub-module 113. Resultantly, the first functional module F1 may allow the same voltage-current characteristics as those of a case in which an inductor having an inductance obtained by multiplying the inductance of the first inductor L1 by the coefficient output from the third sub-module 113 is connected between the terminal a and the terminal d to appear between the terminal a and the terminal d.

Each of the second to fourth functional modules F2 to F4 may be configured in a similar manner as the first functional module F1 shown in FIG. 3, although parameters thereof may be different from those of the first functional module F1.

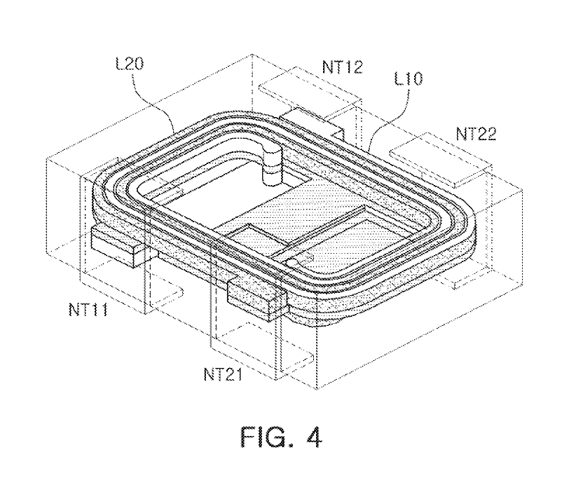

FIG. 4 is a schematic perspective view illustrating a coupled power inductor.

The coupled power inductor may include two inductors L10 and L20 magnetically coupled to each other.

A first inductor L10 may be connected between a terminal NT11 and a terminal NT12, and a second inductor L20 may be connected between a terminal NT21 and a terminal NT22.

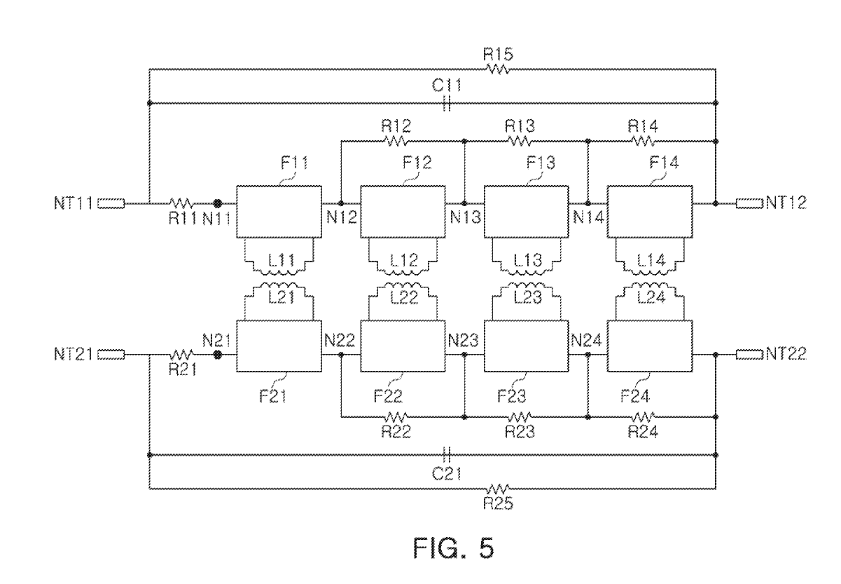

FIG. 5 is a circuit diagram illustrating an equivalent circuit of a coupled power inductor according to an exemplary embodiment in the present disclosure.

The equivalent circuit of the coupled power inductor according to the exemplary embodiment in the present disclosure may include a first resistor R1 connected between the terminal NT11 and a first node N11, a first variable inductance module connected between the first node N11 and a second node N12 and including a functional module F11 and an inductor L11, a second variable inductance module connected between the second node N12 and a third node N13 and including a functional module F12 and an inductor L12, a third variable inductance module connected between the third node N13 and a fourth node N14 and including a functional module F13 and an inductor L13, a fourth variable inductance module connected between the fourth node N14 and the terminal NT12 and including a functional module F14 and an inductor L14, a second resistor R12 connected to the second variable inductance module in parallel, a third resistor R13 connected to the third variable inductance module in parallel, a fourth resistor R14 connected to the fourth variable inductance module in parallel, a capacitor C11 and a fifth resistor R15 disposed between the terminal NT11 and the terminal NT12 and connected to each other in parallel, a sixth resistor R21 connected between the terminal NT21 and a fifth node N21, a fifth variable inductance module connected between the fifth node N21 and a sixth node N22 and including a functional module F21 and an inductor L21, a sixth variable inductance module connected between the sixth node N22 and a seventh node N23 and including a functional module F22 and an inductor L22, a seventh variable inductance module connected between the seventh node N23 and an eighth node N24 and including a functional module F23 and an inductor L23, an eighth variable inductance module connected between the eighth node N24 and the terminal NT22 and including a functional module F24 and an inductor L24, a seventh resistor R22 connected to the sixth variable inductance module in parallel, an eight resistor R23 connected to the seventh variable inductance module in parallel, a ninth resistor R24 connected to the eight variable inductance module in parallel, and a capacitor C21 and a tenth resistor R25 disposed between the terminal NT21 and the terminal NT22 and connected to each other in parallel. In this case, the circuit between the terminals NT11 and NT12 shown in FIG. 5 may be equivalent to the first inductor L10 shown in FIG. 4, the circuit between the terminals NT21 and NT22 shown in FIG. 5 may be equivalent to the second inductor L20 shown in FIG. 4, and a combination of magnetic coupling between the inductors in the circuit between the terminals NT11 and NT12 and magnetic coupling between the inductors in the circuit between the terminals NT21 and NT22 may be equivalent to magnetic coupling between the first inductor L10 and the second inductor L20 shown in FIG. 4.

A total sum of inductances of the inductors L11, L12, L13, and L14 may be set to be the same as an inductance of the first inductor L10 of FIG. 4. In addition, a total sum of inductances of the inductors L21, L22, L23, and L24 may be set to be the same as an inductance of the second inductor L20 of FIG. 4. A coupling coefficient between the inductors L11 and L21, a coupling coefficient between the inductors L12 and L22, a coupling coefficient between the inductors L13 and L23, and a coupling coefficient between the inductors L14 and L24 may be set based on a coupling coefficient between the first and second inductors L10 and L20. For example, a total sum of the coupling coefficient between the inductors L11 and L21, the coupling coefficient between the inductors L12 and L22, the coupling coefficient between the inductors L13 and L23, and the coupling coefficient between the inductors L14 and L24 may be set the same as the coupling coefficient between the first and second inductors L10 and L20.

The variable inductance modules described above may serve as inductors having inductances determined depending on magnitudes of DC currents flowing to an inductor that is to be represented as an equivalent circuit. Functions of the variable inductance modules, particularly, functions of the functional modules F11, F12, F13, F14, F21, F22, F23, and F24 included in the variable inductance modules may be easily understood with reference to a description for FIGS. 2 and 3.

Magnitudes of the resistors R11, R12, R13, R14, R15, R21, R22, R23, R24, and R25 and the capacitors C11 and C12 may be determined depending on physical characteristics, frequency characteristics, and the like, of the coupled power inductor illustrated in FIG. 4.

As set forth above, according to the storage device having an equivalent circuit of an inductor for a simulation stored therein and the server for providing an equivalent circuit of an inductor, DC bias characteristics as well as frequency characteristics may be accurately reflected at the time of the simulation, such that the simulation may be more accurately performed.

While exemplary embodiments have been shown and described above, it will be apparent to those skilled in the art that modifications and variations could be made without departing from the scope of the present invention as defined by the appended claims.

What is claimed is:

1. A storage device storing an equivalent circuit,
wherein the equivalent circuit having a first terminal and a second terminal includes:
a first inductor; and
a first functional module connected to the first inductor and adjusting an inductance of the first inductor depending on a direct current (DC) current flowing from the first terminal to the second terminal, and
the equivalent circuit is an equivalent circuit of an inductor connected between opposite terminals of an inductor device.

2. The storage device of claim 1, wherein the first functional module determines a coefficient corresponding to information on the DC current with reference to a lookup table, determines an adjusted inductance by multiplying the inductance of the first inductor by the coefficient, and operates the same as an inductor having the adjusted inductance connected between a first output terminal and a first input terminal of the first functional module.

3. The storage device of claim 2, wherein the first functional module includes:
a first sub-module obtaining DC current information corresponding to the information on the DC current flowing from the first terminal to the second terminal;
a second sub-module extracting an absolute value of the DC current information and outputting a magnitude of the DC current;
a third sub-module extracting the coefficient corresponding to the magnitude of the DC current with reference to the lookup table;
a fourth sub-module obtaining the inductance of the first inductor; and
a fifth sub-module multiplying the inductance of the first inductor by the coefficient and outputting a result obtained by the multiplication.

4. The storage device of claim 3, wherein the fourth sub-module obtains the inductance of the first inductor by applying a current flowing from the first input terminal to the first output terminal to the first inductor.

5. The storage device of claim 3, wherein the fifth sub-module allows a voltage between the first input terminal and the first output terminal to be a value obtained by multiplying the inductance of the first inductor by the coefficient.

6. The storage device of claim 1, wherein the equivalent circuit further includes:
a second functional module connected between an output terminal of the first functional module and the second terminal; and
a second inductor connected to the second functional module, and
the second functional module adjusts an inductance of the second inductor depending on the DC current.

7. The storage device of claim 6, wherein the equivalent circuit further includes:
a first resistor connected between the first terminal and an input terminal of the first functional module; and
a second resistor connected to the second functional module in parallel.

8. The storage device of claim 7, wherein the equivalent circuit further includes a first capacitor and a third resistor disposed between the first terminal and the second terminal and connected to each other in series.

9. The storage device of claim 7, wherein the equivalent circuit further includes a first capacitor and a third resistor disposed between the first terminal and the second terminal and connected to each other in parallel.

10. A server storing
a file including an equivalent circuit, accessible to a user terminal,
wherein the equivalent circuit having a first terminal and a second terminal includes:
a first inductor; and
a first functional module connected to the first inductor and adjusting an inductance of the first inductor depending on a DC current flowing from the first terminal to the second terminal, and
the equivalent circuit is an equivalent circuit of an inductor connected between opposite terminals of an inductor device.

11. The server of claim 10, wherein the first functional module determines a coefficient corresponding to information on the DC current with reference to a lookup table, determines an adjusted inductance by multiplying the inductance of the first inductor by the coefficient, and operates the same as an inductor having the adjusted inductance connected between a first output terminal and a first input terminal of the first functional module.

12. The server of claim 11, wherein the first functional module includes:
a first sub-module obtaining DC current information corresponding to the information on the DC current flowing from the first terminal to the second terminal;
a second sub-module extracting an absolute value of the DC current information and outputting a magnitude of the DC current;
a third sub-module extracting the coefficient corresponding to the magnitude of the DC current with reference to the lookup table;
a fourth sub-module obtaining the inductance of the first inductor; and
a fifth sub-module multiplying the inductance of the first inductor by the coefficient and outputting a result obtained by the multiplication.

13. The server of claim 10, wherein the equivalent circuit further includes:
a second functional module connected between an output terminal of the first functional module and the second terminal; and
a second inductor connected to the second functional module, and
the second functional module adjusts an inductance of the second inductor depending on the DC current.

14. The server of claim 13, wherein the equivalent circuit further includes:
a first resistor connected between the first terminal and an input terminal of the first functional module; and
a second resistor connected to the second functional module in parallel.

15. The server of claim 14, wherein the equivalent circuit further includes a first capacitor and a third resistor disposed between the first terminal and the second terminal and connected to each other in series.

16. The server of claim 14, wherein equivalent circuit further includes a first capacitor and a third resistor disposed between the first terminal and the second terminal and connected to each other in parallel.
